(19) United States
(12) Patent Application Publication
(10) Pub. No.: US 2009/0307989 A1
(43) Pub. Date: Dec. 17, 2009

(54) OUTBUILDING WITH INTEGRATED ADVERTISING

(76) Inventor: James H. Johnson, Jr., Lexington, KY (US)

Correspondence Address: KING & SCHICKLI, PLLC, 247 NORTH BROADWAY, LEXINGTON, KY, 40507, US

(21) Appl. No.: 11/996,656

(22) PCT Filed: Jul. 25, 2006
(86) PCT No.: PCT/US06/28866

§ 371 Date: Jan. 24, 2008

Related U.S. Application Data
(60) Provisional application No. 60/702,476, filed on Jul. 26, 2005.
(60) Provisional application No. 60/771,397, filed on Feb. 8, 2006.

(51) Int. Cl. E04H 14/00; G09F 13/22; E04D 1/30; G09F 13/00; E04B 1/38; F21L 4/00; F25D 23/00

(52) U.S. Cl. 52/38; 40/544; 52/57; 40/541; 52/698; 362/183; 62/259.1

(57) ABSTRACT

An integrated advertising and building structure includes a housing having a top wall and at least one side wall, a door in the housing for accessing an interior space in the housing and a display device carried on the housing.

This application claims the benefit of U.S. Provisional Patent Application Ser. No. 60/702,476 filed 26 Jul. 2005 and 60/771,397 filed on 8 Feb. 2006.

### TECHNICAL FIELD

The present invention relates generally to the field of advertising and, more particularly, to an outbuilding incorporating an integrated advertising system.

### BACKGROUND OF THE INVENTION

Signs have long been utilized by service providers, retailers and product vendors to promote their services and products. They are also often used to promote political candidates as well as provide public service messages.

Many governmental units pass regulations respecting temporary signage. Often these regulations require that the signage be rotated on a regular basis. The present invention relates to an outbuilding incorporating an integrated advertising system that allows sign rotation and the presentation of high quality digital graphics for line of sight, high quality display and product promotion.

### SUMMARY OF THE INVENTION

In accordance with the purposes of the present invention, an outbuilding incorporating an integrated advertising system is provided. The integrated advertising and building structure comprises a housing including a top wall and at least one side wall, a door in the housing for accessing an interior space in the housing and a display device carried on or in a cavity in the housing. At least a portion of the housing is constructed from modular building panels. The modular building panels include a core of insulating material sandwiched in a protective sheath. The sheath is made from a material selected from a group consisting of a metal, a polymer and a combination thereof.

In one possible embodiment, the display device is an illuminated banner display assembly including a banner constructed from an electroluminescent material. The banner includes printing and more typically digital graphics on a face thereof. When connected to a power source the banner is self-illuminating. In addition the banner display assembly includes a holder carried on the housing that engages the banner and holds the banner open for viewing. Further the invention may include a circuit for the illuminated banner display assembly. In one possible embodiment, the circuit includes a solar cell, a battery and an actuator selected from a group consisting of a timer, a light sensor and an activation switch.

In accordance with an additional aspect of the present invention in one possible embodiment the structure further includes a climate control device that provides climate control for the interior space of the housing. In addition, the structure may include an optional light source carried by the housing and provided to selectively illuminate the interior space. A circuit may be provided for this light source. In one possible embodiment, that circuit includes a solar cell, a battery and an actuator selected from a group consisting of a timer, a light sensor, an activation switch or any combination thereof. Further the structure may include an optional decorative roof cap.

In an additional possible embodiment of the invention, the illuminated banner display assembly includes a holder carried on the housing, a banner held in the holder and a light source back lighting the banner. This embodiment may also include a circuit for the light source. That circuit may include a solar cell, a battery and an actuator selected from a group consisting of a timer, a light sensor, an actuator switch or any combination thereof. The backlit banner may include a face printed with digital graphics. Further the structure may include a climate control device providing climate control for the interior space of the housing. This embodiment may also include an optional decorative roof cap if desired.

In accordance with yet another aspect of the present invention, the housing may include a floor. In addition an anchor may be provided to secure the housing to the ground.

In the following description there is shown and described a preferred embodiment of this invention, simply by way of illustration of one of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWING

The accompanying drawings incorporated in and forming a part of this specification, illustrates several aspects of the present invention and together with the description serves to explain certain principles of the invention. In the drawing:

FIG. 1 is a perspective view of the integrated advertising and building structure of the present invention;

FIG. 2 is a schematical end elevational view of the structure of FIG. 1 through the open end doors;

FIG. 3 is a perspective view of one possible embodiment of the illuminated banner display assembly of the present invention;

FIG. 4 is a detailed side elevational view of the banner display assembly with the side wall removed illustrating how the banner is connected to the stretcher;

FIG. 5 is a view similar to FIG. 4 showing how the banner is pulled open and made taut in the holder;

FIG. 6 is a schematical view showing a banner display assembly or electronic display device mounted on a side wall, end wall or doors of an integrated advertising and building structure; and

FIG. 7 is a schematical view showing a banner display assembly or electronic display device mounted in a cavity in a side wall, end wall or door of an integrated advertising and building structure.

### DETAILED DESCRIPTION OF THE INVENTION

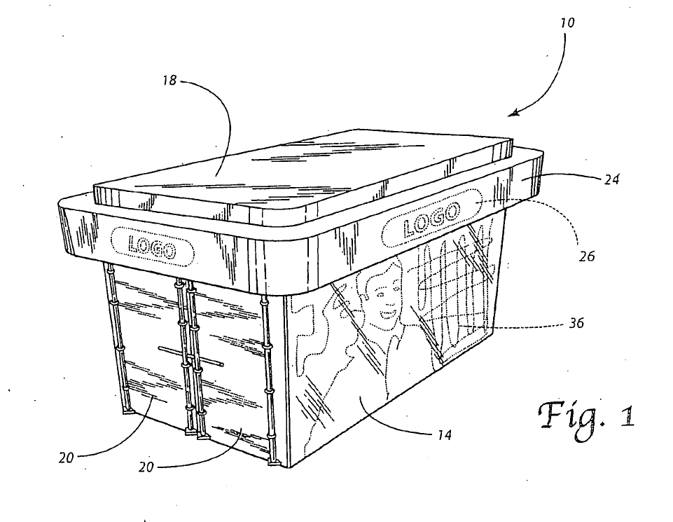

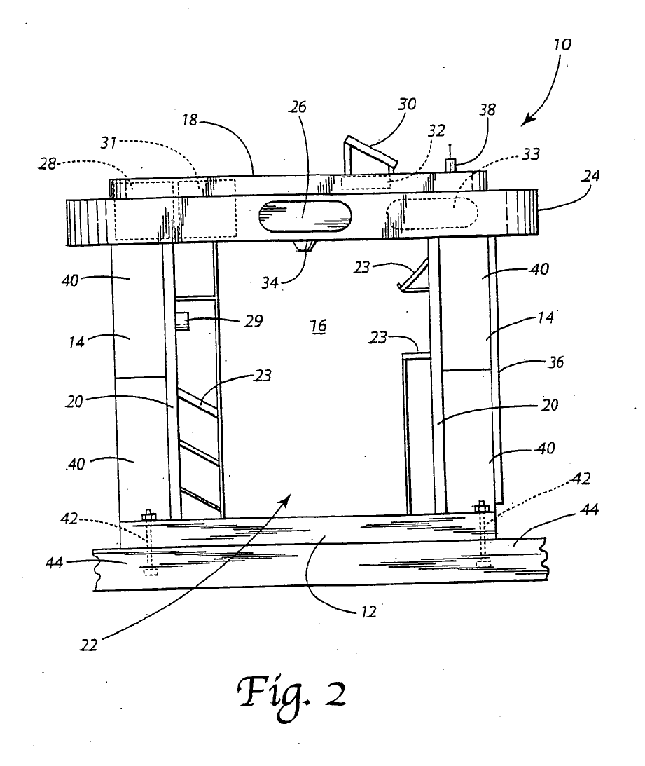

One possible construction of an integrated advertising and building structure or “box billboard” 10 is illustrated in FIGS. 1-2. More specifically, the structure 10 includes a floor 12, two side walls 14, an end wall 16 and a roof 18. A pair of cooperating, locking doors 20 define a second end wall opposite the first end wall 16. Any type of door 20 useful for the intended purpose may be utilized. Together, the floor 12, side walls 14, end walls 16, roof 18 and doors 20 define an interior space 22. That space 22 may be customized to meet the needs of a product vendor, product retailer or any other user, including particular rack, shelving and/or partitioning layouts (note shelves 23) as required or desired by the customer for purposes of inventory storage and control.

Similarly, the exterior of the structure 10 may be customized to match the trade dress of substantially any desired party and/or architectural features of any building near which the structure 10 may be placed into service. Thus, for example, the structure 10 may include a decorative roof cap 24 sized and shaped to a user's specifications. The roof cap 24 may include user advertising, trade dress or logo 26 if desired and/or as allowed by local regulations.

The structure 10 may also be equipped with various electrical and/or mechanical systems. For example, a climate control unit such as an air conditioner, refrigerator, freezer, humidifier or dehumidifier 28 may be provided on the structure 10 in order to provide climate control of a portion or all of the space 22 within the storage structure. Accordingly, products such as perishable food, dairy products, soft drinks and beer may be maintained at the desired temperatures even in hot and humid environments.

In addition, the structure 10 may be equipped with a solar panel 30 and cooperating battery 32 to store energy for powering an internal lighting system 34 for illuminating the space 22 or illuminating advertising 36 on the side wall 14, end wall 16 or other exterior component of the structure 10. That advertising 36 may comprise a stretched banner material and it may be front lit or back lit as desired. In another possible embodiment, the banner may be made from a self-illuminating electroluminescent material such as a film or foil of a type known in the art and described in, for example, U.S. Pat. Nos. 5,767,451 and 6,637,906.

If desired, power for all the electrical and mechanical components of the structure 10 may be provided through an electrical circuit box 29 carried on the housing 10 and connected to the lines of the local electric utility supplier. Alternatively, the housing 10 may carry an electric generator 31. In one possible embodiment, the generator 31 may be driven by natural gas and connected to the underground supply line of the local natural gas provider. In another possible embodiment, the generator 31 may be driven by propane and the structure may further include a propane storage tank 33 for supplying propane to the generator. Of course, that propane storage tank 33 could also be provided underground. In yet another alternative, the electric generator 31 is powered by a fuel cell.

Still further, the structure 10 may incorporate a radio transmitter 38 for the transmission of short range advertisements respecting products displayed in the advertising 36 appearing on the exterior surface of the structure 10. A particularly effective advertising combination is the use of an illuminated digital graphic advertising banner 36 in conjunction with local transmission radio advertising providing details of a particular product. This is particularly effective when advertising a product that is sold from the structure 10 or the place of business adjacent the structure.

The structure 10 may be constructed from modular building materials such as prefabricated panels 40 of the type shown and described in, for example, U.S. Pat. Nos. 6,279,287 to Meadows, 5,373,678 to Hesser and 6,119,427 to Wyman et al. Such modular panels 40 typically incorporate a core of thermal insulating material sandwiched between metal or plastic sheathing. Such a construction provides both efficient and effective control of the temperature and humidity of the environment in the internal space 22 and excellent inclement weather durability for a long, low-maintenance service life. Structures 10 constructed from such modular building panels 40 are also characterized by high strength and will resist high winds and maintain a weather-tight enclosure to protect products held in the space 22 from inclement weather. In fact, such structures may be easily anchored to the ground such as by means of cooperating nut and bolt anchors 42 where the bolt is received and held in an underlying poured concrete pad 44. The modular panels 40 also allow the structure 10 to be quickly and easily erected and subsequently removed in a minimal amount of time while producing a minimum of mess.

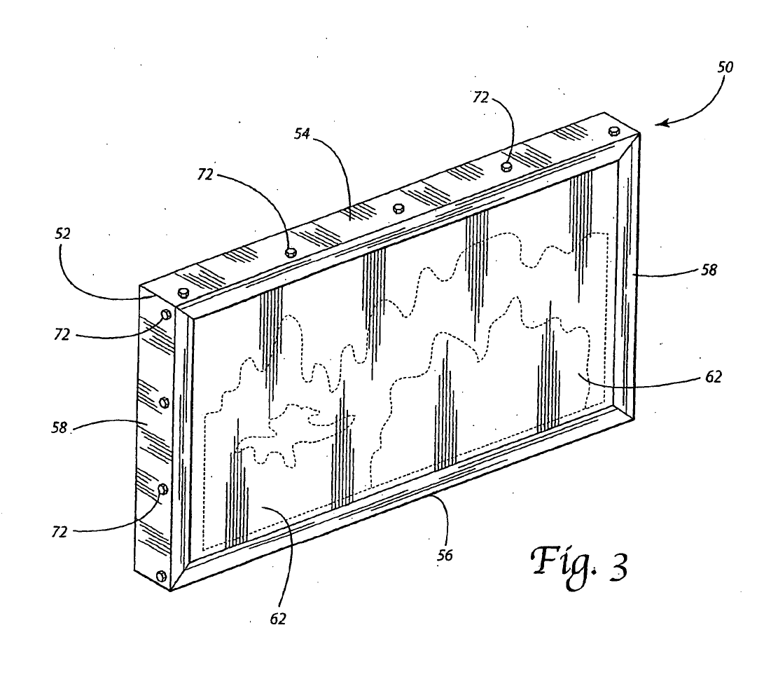

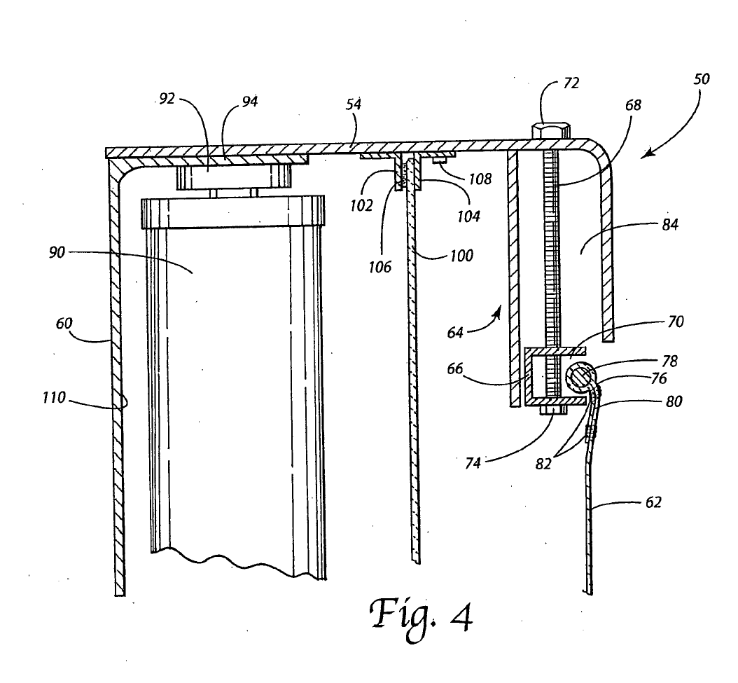

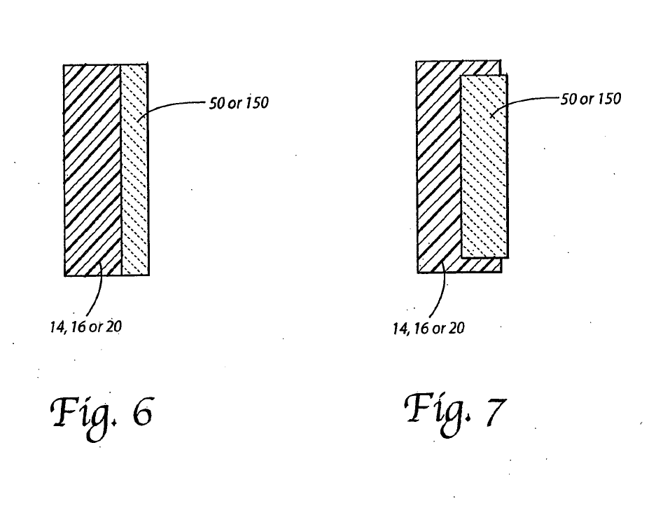

Reference is now made to FIGS. 3-5 illustrating a banner display assembly 50 of the type that may be carried on or in a cavity in the side wall 14, end wall 16 or door 20 of the structure 10 (see FIGS. 6 and 7). Any appropriate mounting brackets and/or fasteners (not shown) may be used to secure the assembly 50 to the structure 10. The assembly 50 includes a frame 52 constructed from a top wall 54, bottom wall 56 and two side walls 58. The frame 52 may also include a rear wall 60. The various walls 54, 56, 58, 60 may be constructed from any appropriate material including polymer, polymer reinforced with fibers such as glass fibers and metal such as aluminum or stainless steel. The walls 54, 56, 58, 60 may be molded, forged, extruded or formed by any other appropriate process suitable for the intended purpose. As illustrated in FIG. 4, the assembly 50 also includes a banner 62. The banner 62 may be printed with an image 36 to be displayed. In one possible embodiment that image 36 is digitally printed on the front face of the banner 62.

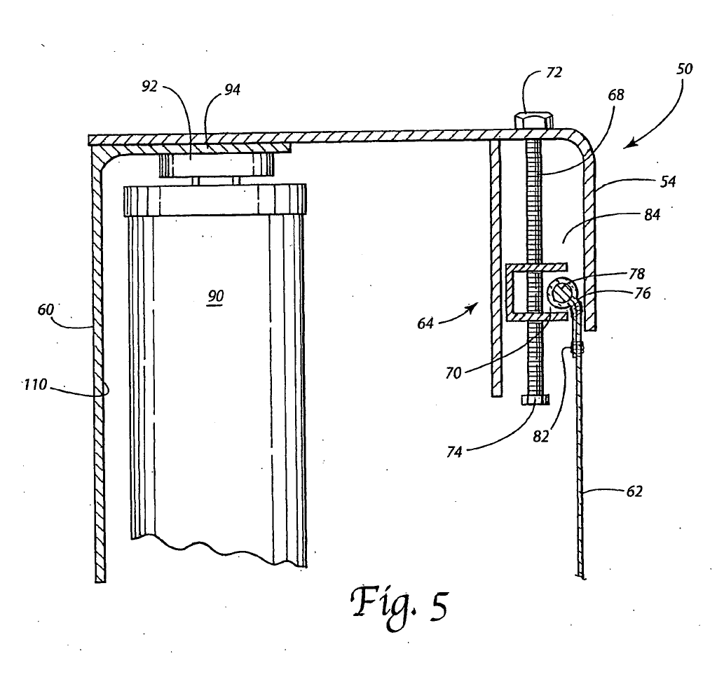

It should be appreciated that the banner 62 is pulled taut in at least the horizontal or vertical directions and preferably in both the horizontal and vertical directions in order to open the banner, remove any wrinkles and provide an aesthetically pleasing image 36. Toward this end, the assembly 50 includes a series of stretchers 64. More specifically, the top wall 54, bottom wall 56 and side walls 58 are all provided with a stretcher 64. As illustrated in FIGS. 4 and 5, each stretcher 64 includes a substantially U-shaped holder 66 and a cooperating tensioner 68. As illustrated the U-shaped holder 66 includes a channel 70. The purpose or function of the channel 70 will be described in greater detail below. In the illustrated embodiment the tensioner 68 comprises a series of spaced bolts. Each bolt includes a head 72 at one end and a stop 74 at the opposite end. The threaded portion of the tensioner 68 engages in apertures provided in the holder 66.

As further illustrated in FIGS. 4 and 5, the banner 62 includes a main body surrounded by a margin 76. The margin 76 is folded over and captures a bead or rod 78 that may be constructed from a cord, plastic, wire or other appropriate material. The overlapped portion of the margin 76 may be secured by an adhesive 80 and/or stitching 82 so as to capture the bead 78. Such a bead 78 is provided in the margin 76 along each side of the banner (i.e. all four sides as illustrated in FIG. 3). The banner 62 is installed in the assembly 50 by loosening each of the tensioners 68 so that the opened end of each holder 66 is exposed with respect to the associated wall 54, 56 or 58 (see FIG. 4). The top bead 78 of the banner 62 is then inserted in the exposed channel 70.

A similar procedure is then completed along the bottom and sides of the banner 62. More specifically, the bead 78 at the bottom of the banner 62 is inserted in the holder 66 of the stretcher 64 provided on the bottom wall 56. Similarly, beads 78 at both sides of the banner 62 are inserted and captured in the stretchers 64 at the side walls 58. The tensioners 68 along the top wall 54, bottom wall 56 and side walls 58 are then tightened to draw the respective beads 76 into the cavities 84 where they are captured in the channels 70 behind the walls 54, 56, 58. In this way the banner 62 is centered on the frame 52 and pulled open and taut so as to eliminate any wrinkles. As should be appreciated from reviewing FIG. 3, the tensioners 68 are provided at spaced locations along the top wall 54, the bottom wall 56 and side walls 58 to insure that the banner 62 is pulled taut along its entire length and width.

A light source 90 is provided in the rear of the assembly 50 adjacent the rear wall 60. As illustrated in FIGS. 4 and 5, the light source 90 is a series of fluorescent lamps that are secured in electrical sockets 92 provided at each end and held on upper and lower flanges 94 of the rear wall 60. As should be appreciated the upper wall 54 is seamless so as to prevent moisture from entering the assembly through the top wall. The side walls 58 and bottom wall 56 may also be of seamless construction if desired.

As should be appreciated, the assembly 50 may also incorporate a transparent partition 100 made from plexiglass or other appropriate material. The partition 100 may be seated between two cooperating angle iron frames 102, 104 provided along the top wall 54, bottom wall 56 and side walls 58. An O-ring, rubber gasket or other seal 106 may be provided between the angle iron frame 102 and the partition 100 so that the partition provides a sealed compartment for the light source 90 in conjunction with the top wall 54, bottom wall 56, side walls 58 and rear wall 60. Screws or other fasteners 108 may be provided at spaced locations to secure the angle iron frame 104 in position. By removing the screws 108 the angle iron frame 104 may be removed so as to allow removal of the partition 100 and access to the light source 90.

As illustrated in FIG. 1, the light source 90 comprises a series of light sources such as fluorescent lamps provided at spaced locations and extending vertically between the top wall 54 and the bottom wall 56. Alternatively, the series of light sources 90 may extend horizontally between the side walls 58 if desired. Further, other types of light sources may be utilized including halogen, mercury vapor, incandescent, LED and substantially any other appropriate means of illumination known in the art. A reflective foil or coating 110 may be provided along the inner face of the rear wall 60 to direct the light toward the front of the assembly 50 and through the banner 62.

The banner 62 is typically made from a material that both allows the passage of light (e.g. transparent or translucent) and may be printed with an image. Appropriate banner materials are available from a number of manufacturers including, for example, Avery Dennison Corporation (Pasadena, Calif.) and 3M Company (St. Paul, Minn.). Such materials allow the printing of digital graphics which when backlit by the light source 90 provide a very sharp and distinct visual display that is very aesthetically pleasing and effective in promoting a product, service or the like.

In still another alternative embodiment, the banner 62 may be made from an electroluminescent material such as an electroluminescent foil or film as described in, for example, U.S. Pat. No. 6,637,906. An image in printed on the face of the banner 62. When properly powered, such a banner 62 is self-illuminating. Accordingly, the banner display assembly 50 for a banner 62 of electroluminescent material need not include a separate light source 90 or any associated partition 100. In such an embodiment, the assembly 50 need only comprise the frame 52 and the stretchers 64 for holding the banner 62.

Many jurisdictions around the country have ordinances in effect that require the rotation of temporary signs such as the banner 62. It should be appreciated that the present invention allows one to quickly and easily change the banner 62. This is true even if the worker has no experience in changing banners. Specifically, the tensioners 68 along the top wall 54, bottom wall 56 and side walls 58 are all loosened until the holders 66 engage the stops 74 and the open end of the channels 70 are exposed. The banner 62 is then manipulated to pull the beads 78 from the channels 70 and the old banner is then removed. The new banner 62 is then positioned with the beads 78 in the channels 70. The tensioners 68 are then tightened until all of the beads 78 are captured behind the walls 54, 56 and 58 and the banners are taut and wrinkleless.

In yet another embodiment, an electronic display device 150 is carried on and in a cavity in the side wall 14, and wall 16 or door 20 of the structure 10 (see FIGS. 6 and 7). Any appropriate mounting brackets or fasteners (not shown) may be used to secure the display device 150 to the structure 10. The display device 150 may comprise a liquid crystal display, a plasma monitor, a rotating sign assembly such as disclosed in, for example, U.S. Pat. No. 4,021,946, an electronic message board or the like.

The foregoing description of a preferred embodiment of the present invention has been presented for purposes of illustration and description. It is not intended to be exhaustive or to limit the invention to the precise form disclosed. Obvious modifications or variations are possible in light of the above teachings. For example, the door 20 may be provided in the side wall 16 rather than the end wall. Further, more than one set of doors 20 may be provided if desired. In fact, the interior space 22 may be partitioned and separate doors may be provided to access each separate, partitioned space. Such an arrangement allows one to stage product. For example, a retailer could lease a refrigerated space in the structure 10 to a beer distributor and another space to a soft drink distributor. The distributors benefit since the staging of their products at the retail site reduces the number of trips required by delivery trucks thereby reducing operating costs. The retailer benefits by reducing delivery truck traffic.

The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims and their fair and broad interpretation in any way.

What is claimed:

1.) An integrated advertising and building structure, comprising:
a housing including a top wall and at least one side wall;
a door in said housing for accessing an interior space in said housing; and
a display device carried on said housing;
said structure being characterized by at least a portion of said housing being constructed from modular building panels.

2.) The structure of claim 1, wherein said modular building panels include a core of insulating material sandwiched in a protective sheath.

3.) The structure of claim 2, wherein said sheath is made from a material selected from a group consisting of a metal, a polymer and a combination thereof.

4.) The structure of claim 1, wherein said display device is an illuminated banner display assembly including a banner constructed from an electroluminescent material.

5.) The structure of claim 4, wherein said banner includes printing on a face of said banner.

6.) The structure of claim 5, wherein said banner includes a face printed with digital graphics.

7.) The structure of claim 5, wherein said illuminated banner display assembly includes a holder carried on said housing that engages said banner and holds said banner open for viewing.

8.) The structure of claim 5, further including a circuit for said illuminated banner display assembly, said circuit including a solar cell, a battery and an actuator selected from a group consisting of a timer, a light sensor, an activation switch or any combination thereof.

9.) The structure of claim 1, further including a climate control device providing climate control for said interior space in said container.

10.) The structure of claim 1, further including a light source carried by said housing provided to selectively illuminate said interior space.

11.) The structure of claim 1, further including a decorative roof cap.

12.) The structure of claim 1, wherein said illuminated banner display assembly includes a holder carried on said housing, a banner held in said holder and a light source back lighting said banner.

13.) The structure of claim 12, further including a circuit for said light source including a solar cell, a battery and an actuator selected from a group consisting of a timer, a light sensor, an actuator switch or any combination thereof.

14.) The structure of claim 13, wherein said banner includes a face printed with digital graphics.

15.) The structure of claim 1, further including a floor.

16.) The structure of claim 1, further including an anchor securing said housing to said ground.

17.) The structure of claim 1, wherein said side wall includes a cavity and said illuminated banner display assembly is at least partially received in said cavity.

18.) An integrated advertising and building structure, comprising:
a housing including a top wall and at least one side wall;
a door in said housing for accessing an interior space in said housing;
a display device carried on said housing; and
a climate control device providing climate control for said interior space in said container.

19.) An integrated advertising and building structure, comprising:
a housing including a top wall and at least one side wall;
a door in said housing for accessing an interior space in said housing;
a display device carried on said housing; and
a decorative roof cap carried on said housing.

20.) An integrated advertising and building structure, comprising:
a housing including a top wall and at least one side wall;
a door in said housing for accessing an interior space in said housing;
a display device carried on said housing; and
an electrical circuit box carried on said housing and connected to electrical utility lines.

21.) An integrated advertising and building structure, comprising:
a housing including a top wall and at least one side wall;
a door in said housing for accessing an interior space in said housing;
a display device carried on said housing; and
a gas driven electric generator.
